(19) United States
(12) Patent Application Publication
(10) Pub. No.: US 2005/0246945 A1
(43) Pub. Date: Nov. 10, 2005

(54) Insect capturing device

(76) Inventor: David Evink, Hancock, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/125,407

(22) Filed: May 9, 2005

Related U.S. Application Data
(60) Provisional application No. 60/569,707, filed on May 10, 2004.

(51) Int. Cl. A01M 1/06

(52) U.S. Cl. 43/139

(57) ABSTRACT

An insect capturing device includes a body defining an interior space, a nozzle for disposing proximate an insect victim and being in fluid communication with the body interior space, and a mechanically generated, momentary vacuum being selectively generated to substantially instantaneously draw the insect victim into a capture space, the capture space being in fluid communication with both the nozzle and the body interior space. A method of capture is further included.

### RELATED APPLICATIONS

The present application claims the benefit of U.S. Provisional Patent Application No. 60/569,707, filed May 10, 2004, and is included herein in its entirety by reference.

### FIELD OF THE INVENTION

The present invention relates to insect capturing and/or destroying. More particularly, the present invention is a hand-held, spring-loaded device for capturing or destroying bugs or other insects using suction, and holding the bugs in a container.

### BACKGROUND OF THE INVENTION

In the past, there have been insect collectors that have been cumbersome and large, or very complex, or electrically operated, or rely on stored compressed air. There is a need for a bug catcher that is small and compact, does not use harsh chemicals (so that it may be used in food service areas), does not need electricity. It should be small and compact so that it might be used in relatively confined areas, such as the cab of a vehicle, be simple in construction, e.g. not many moving parts and be lightweight.

### SUMMARY OF THE INVENTION

The insect capturing device of the present invention meets the aforementioned needs of the industry. It is small and compact, preferably about the size of a standard aerosol can, so that it might be used in relatively confined areas, such as the cab of a vehicle. It is self-contained and relies on a self-generated vacuum and does not use harsh chemicals, so that it may be used in food service areas. Being self-contained and relying on a self-generated vacuum, it does not need electricity. It is simple in construction, having very few moving parts in order to keep costs down and to increase reliability and it is lightweight, preferably being made substantially of plastic. Preferably, an embodiment of the insect capturing device of the present invention is intended and sized appropriately for ingesting insect victims similar in size to the common housefly.

The present invention is an insect capturing device, including a body defining an interior space, a nozzle for disposing proximate an insect victim and being in fluid communication with the body interior space, and a mechanically generated, momentary vacuum being selectively generated to substantially instantaneously draw the insect victim into a capture space, the capture space being in fluid communication with both the nozzle and the body interior space. A method of capture is further included in the present invention.

### BRIEF DESCRIPTION OF THE DRAWINGS

FIG. 1 is a sectional view of one embodiment of the present invention in the cocked disposition.

FIG. 1a is a sectional view of an optional telescoping tube extension.

FIG. 2 is a perspective view of one embodiment of the present invention.

FIG. 3a is a frontal view of a shutter in the closed position according to the present invention.

FIG. 3b is a frontal view of a shutter in the open position according to the present invention.

FIG. 4 is a sectional view of a further embodiment of the present invention.

### DETAILED DESCRIPTION OF THE DRAWINGS

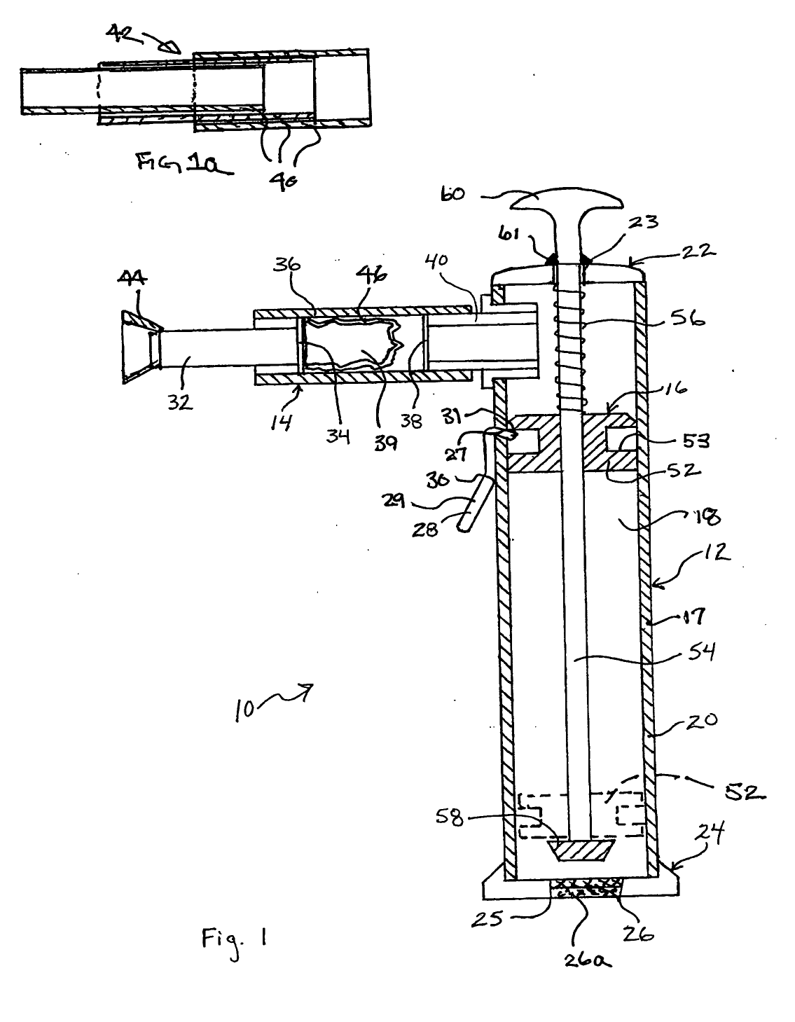

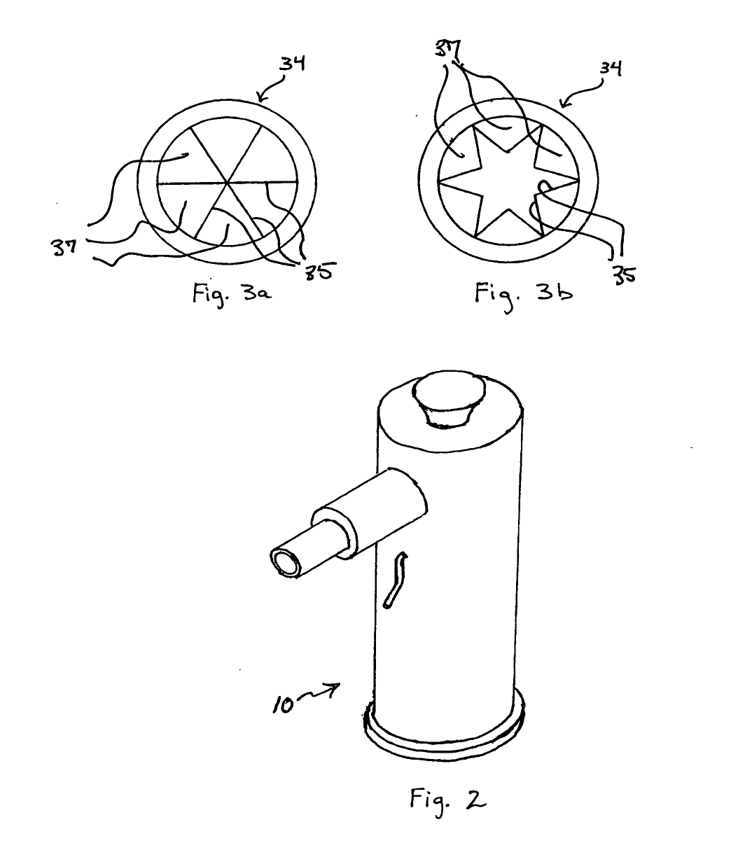

Referring generally to FIGS. 1-3b, one exemplary embodiment of the insect capturing device of the present invention is shown generally at 10. Insect capturing device 10 generally includes a handle 12, intake portion 14, and a piston arrangement 16.

Handle 12, in this embodiment, is preferably cylindrically shaped, although it is contemplated that other profiles may also be suitable. Handle 12 includes a cylindrical body 20, having a top portion 22 and a bottom portion 24 and having a wall 17, the inner margin of the wall 17 defining a cylinder 18. Top portion 22 includes a vent 23 annular to a rod 54 (discussed in greater detail below) or vent 23 may simply be one or more openings in top portion 22.

Bottom portion 24 includes an opening 25, which may include a mesh insert 26. An air filter 26a may be coupled to mesh insert 26, or mounted proximate to opening 25. Top portion 22 and bottom portion 24 may be fixedly coupled to cylindrical body 20 as by bonding therewith or welding thereto or top portion 22 and bottom portion 24 may be removably coupled to cylindrical body 20, as by threads or the like. Handle 12 also includes a trigger mechanism 28, which is attached to cylindrical body 20 and communicates with piston arrangement 16. It is contemplated that handle 12 may be constructed from plastic, metal, or other suitable materials.

A trigger 28 is shiftably disposed in a bore 27 defined in the cylinder body 20. The trigger 28 has a lever 29 adjacent a fulcrum 30. A trigger tang 31 projects into the cylinder 18. A finger of an operator may engage the lever 29.

Insect capturing device 10 further comprises an intake portion 14, which includes a nozzle 32 and a containment tube 36. Intake portion 14 may also include one or more extension tubes 40, or a telescoping tube assembly 42, as depicted in FIG. 1a, and having a series of concentric translatable tubes 40. Intake portion 14 is preferably oriented orthogonally with respect to handle 12, and is located proximate top portion 22. Containment tube 36 may be removably coupled to cylindrical body 20. Containment tube 36 may also be removably coupled to one or more extension tubes 40, which are in turn removably coupled to cylindrical body 20.

A nozzle 32 is coupled to containment tube 36, and both nozzle 32 and containment tube 36 may be constructed from rubber, plastic, or other suitable materials and may be substantially one quarter of an inch in interior diameter in a preferred embodiment. A funnel 44 may optionally be coupled to nozzle 32 in order to aid in ingesting insects that are larger than the common housefly, such as spiders and the like.

Nozzle 32 is exposed on one end to the atmosphere, and on the other end communicates with a flapper or shutter 34, which is included in containment tube 36. In the alternative, shutter 34 may be included in nozzle 32. Shutter 34 is preferably constructed from rubber, or rubber-like material that exhibits a resilient bias for the disposition of FIG. 3a and features a plurality of radial slits 35. As best seen in FIGS. 3a and 3b, the slits 35 in shutter 34 create a plurality of wedge-shaped portions 37 that allow the shutter 34 to open in the presence of a negative or positive air pressure, as depicted in FIG. 3b. As noted above, the wedge-shaped portions 37 are resiliently biased in the closed disposition of FIG. 3a in the presence of ambient air pressure and are open to admit an insect victim, as depicted in FIG. 3b only in the presence of the ingesting momentary vacuum. When closed, the shutter captures an insect victim in the insect capturing space 39.

The insect capturing space 39 is defined adjacent the nozzle 32 and in part by a mesh screen 38 is also included in intake portion 14 at an inward end and by the shutter 34 at an outward. The screen 38 is air permeable such that a vacuum is not prevented from reaching the nozzle 32, but will prevent an insect victim from being ingested into the cylinder 18 of the body 20. Screen 38 may be coupled to containment tube 36, or may be coupled to an extension tube 40 or telescoping tube 42, as depicted in FIG. 1a. Additionally, a disposable, air-permeable bag or liner 46 may be included in containment tube 36. Such liner 46 may be of similar construction to a paper vacuum cleaner bag or the like, but on a much reduced size scale.

A piston arrangement 16 is included in the device 10. A piston or plunger 52 is coupled to the rod 54, and is housed within the cylinder 18 of the cylindrical body 20. Piston 52 is translatable within the cylinder 18 and has an outer margin profile identical to that of the cylinder 18 of cylindrical body 20, so as to create a substantially airtight seal therewith. Rod 54 includes a bumper stop 58 at one end, and a knob 60 at the other end. When knob 60 is in contact with top portion 22, a annular collar 61 sealingly covers vent 23.

A biasing compression spring 56 is disposed concentric with and wrapped around rod 54, and is located between top portion 22 and piston 52. In FIG. 1, the piston 52 is depicted in its cocked disposition with the spring maximally compressed. The piston 52 is translatable relative to the rod 54, as noted by the two dispositions of the piston 52 in FIG. 1. It is contemplated that piston 52 does not interact with, or pass by intake portion 14 in the range of travel of piston 52.

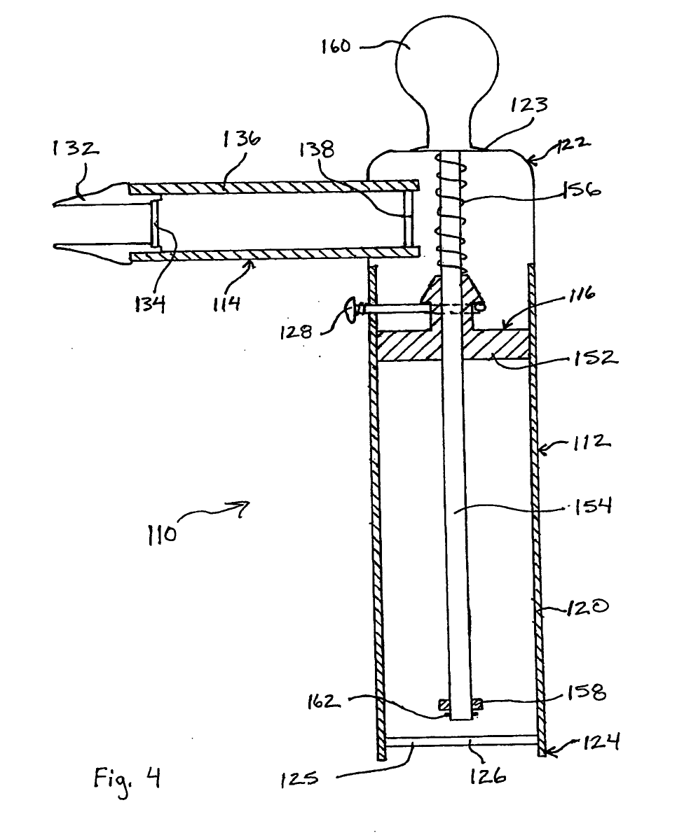

Referring now to FIG. 4, an alternative embodiment of the present invention is depicted. In the embodiment of FIG. 4 like components as are described with reference to the FIGS. 1-3 are indicated by a numeral increased by 100. Accordingly, insect capturing device 110 includes a handle 112, intake portion 114, and a piston arrangement 116. Handle 112, in this embodiment, is preferably cylindrically shaped, although it is contemplated that other profiles may also be suitable. Handle 112 includes a cylindrical body 120, having a top portion 122 and a lower portion 124. Top portion 122 includes a vent 123, which may simply be one or more openings in top portion 122. Lower portion 124 includes a opening 125, which may include a mesh insert 126. An air filter may be coupled to mesh insert 126, or mounted proximate to opening 125. Top portion 122 and lower portion 124 may or may not be separably coupled to cylindrical body 120. Handle 112 also includes a trigger mechanism 128, which is attached to cylindrical body 120 and communicates with piston arrangement 116. In the present embodiment trigger 128 is hook shaped, engaging the profile of piston 152. It is contemplated that handle 112 may be constructed from plastic, metal, or other suitable materials.

Insect capturing device 110 further comprises an intake portion 114, which includes a nozzle 132 and a containment tube 136. Intake portion 114 may also include one or more extension tubes 140, or a telescoping tube assembly 142 (not shown). Intake portion 114 is oriented orthogonally to handle 112, and is proximate to top portion 122. Containment tube 136 may be removably coupled to cylindrical body 120. Containment tube 136 may also be removably coupled to one or more extension tubes 140 (not shown), which are in turn removably coupled to cylindrical body 120.

A nozzle 132 is coupled to containment tube 136, and both may be constructed from rubber, plastic, or other suitable materials. A funnel 144 (not shown) may be coupled to nozzle 132. Nozzle 132 is exposed on one end to the atmosphere, and on the other end communicates with a flapper or shutter 134, which is included in containment tube 136. In the alternative, shutter 134 may be included in nozzle 132. Shutter 134 is likely constructed from rubber, or rubber-like material, and features a plurality of slits. The slits in shutter 134 create a plurality of wedge-shaped portions that allow the shutter to open in the presence of a negative or positive air pressure. A mesh screen 138 is also included in intake portion 114. Screen 138 may be coupled to containment tube 136, or may be coupled to an extension tube 140 or telescoping tube 142. Additionally, a disposable bag or liner 146 may be included in containment tube 136.

A piston arrangement 116 is included in the device 110. A piston or plunger 152 is coupled to a rod 154, and is housed within cylindrical body 120. Piston 152 has a profile identical to that of the inside of cylindrical body 120, so as to create a seal. Rod 154 includes a bumper stop 158 at one end, and a knob 160 at the other end. When knob 160 is in contact with top portion 122, knob 160 covers vent 123. A compression spring 156 is wrapped around rod 154, and is located between top portion 122 and piston 152. Bumper stop 158 is coupled to rod 154 with a retaining ring 162. It is contemplated that piston 152 does not interact with, or pass by, intake portion 114 in the range of travel of piston 152.

The operation of the present invention is described as follows. To capture an insect or other item using insect capturing device 10 (or 110), an operator holds handle 12 in his/her hand and pulls knob 60 vertically and away from top portion 22. In doing so, knob 60 uncovers vent 23, allowing air to be displaced out of vent 23. Piston 52 is engaged by the bumper stop 58 and piston 52 is thereby raised in cylinder 18 by pulling up on knob 60 extending knob away from the cylindrical body 20, until piston 52 engages trigger mechanism 28, cocking device 10. In the cocked disposition, tang 31 engages the annular groove 53. When device 10 is in the cocked position, spring 56 is maximally compressed against piston 52 and knob 60 may be returned to its resting position on top portion 22, covering vent 23.

Once insect capturing device 10 is in the cocked position, an operator positions the nozzle 32 of device 10 proximate to the object desired to be captured. Pressing the lever 29 of the trigger 28 causes the tang 31 to disengage from the annular groove 53, thereby releasing piston 52 and thereby causing spring 56 to expand very rapidly, pushing piston 52 downward toward bumper stop 58 at a great rate of speed. As piston 52 travels downwards, air is forced out of the opening 25 in bottom portion 24. Simultaneously, suction is created in the upper portion of the cylinder 18 of the cylindrical body 20 (between piston 52 and upper portion 22), and in intake portion 14 as piston 52 travels downwards. The suction opens flapper 34, causing air to be drawn in at relatively high velocity through containment tube 36 and into cylindrical body 20. An insect or other object proximate to nozzle 30 when trigger 28 is pressed will be drawn in through nozzle 32 and into the capture space 39 defined in the containment tube 36. Screen 38 (or liner 46) prevents objects drawn into the capture space 39 from passing through to the cylinder 18 of the cylindrical body 20.

Piston 52 travels between a cocked disposition as depicted in solid lines in FIG. 1 to a stopped disposition as depicted in dashed lines in FIG. 1. As piston 52 travels downward on rod 54, it encounters bumper stop 58. Bumper stop 58 is preferably constructed from rubber, or similar material, to provide a damping effect and reduce the noise created as piston 52 strikes stop 58. The spring 56 is then in its least compressed disposition. Once piston 52 has come to rest on bumper stop 58 in the stopped disposition, there is no longer suction present in containment tube 36, and flapper 34 is closed. The insect is then trapped in the capture space 39, between flapper 34 and screen 38. Depending on the robustness of the insect, it may or may not survive the capturing process. To capture subsequent insects or other objects, the process may be repeated by again pulling knob 60 vertically and away from top portion 22 to return the piston 52 to the cocked disposition.

When an operator desires to empty containment tube 36, intake portion 14 is removed from handle 12, and the contents of tube 36 may be disposed of. If a disposable bag or liner 46 is used with containment tube 36, bag 46 is removed and disposed of.

To retrieve insects or other objects from a distant surface, a series of extension tubes 40, or a telescoping tube assembly 42, as depicted in FIG. 1a, may be removably attached between containment tube 36 and cylindrical tube 20. It may also be desirable to attach funnel 44 to nozzle 32 to aid in the capture of insects. Funnel 44 helps direct an insect or other object into nozzle 32.

The operation of insect capturing device 110 is substantially similar to the operation of device 10 described above.

It will be obvious to those skilled in the art that other embodiments in addition to the ones described herein are indicated to be within the scope and breadth of the present application. Accordingly, the applicant intends to be limited only by the claims appended hereto.

1. An insect capturing device, comprising
a body defining an interior space;
a nozzle for disposing proximate an insect victim and being in fluid communication with the body interior space;
a mechanically generated, momentary vacuum being selectively generated to substantially instantaneously draw the insect victim into a sealable capture space, the capture space being in fluid communication with both the nozzle and the body interior space.

2. The insect capturing device of claim 1 including a biasable piston being translatably disposed in the body.

3. The insect capturing device of claim 1 including the piston being translatable between a cocked disposition and a stopped disposition.

4. The insect capturing device of claim 1 including the piston being forcibly, selectively translatated from the cocked disposition to the stopped disposition, the translation generating the vacuum.

5. The insect capturing device of claim 1 including a biasable piston being translatably disposed in a space defined in the body, the space being at ambient conditions at all times until the occurrence of the biased translation of the piston.

6. The insect capturing device of claim 1 including the body being selectively vented to ambient air conditions on both of two opposed sides of the piston.

7. The insect capturing device of claim 2 including the vacuum being generated only while the piston is in translation from a cocked disposition to a stopped disposition, the body interior space being at ambient air pressure conditions at all other times.

8. The insect capturing device of claim 7 including the vacuum being generated at the nozzle.

9. The insect capturing device of claim 1 including the capture space being valved to a closed disposition at a first end under ambient conditions.

10. The insect capturing device of claim 1 including the capture space being opened at a first end under vacuum conditions for admittance of the insect victim thereto.

11. An insect capturing device, comprising:
a body having an interiorly defined space,
a piston translatably disposed in the interiorly defined space;
a biasing spring disposed on a first side of the piston;
a nozzle including a capture space being in fluid communication with the interiorly defined space on the first side of the piston; and
a trigger disposed to selectively retain the piston in a cocked disposition.

12. The insect capturing device of claim 11 being operable with a single operator's hand and including the body being a handle for grasping by the hand.

13. The insect capturing device of claim 1 1, the nozzle being orthogonally disposed relative to the body.

14. The insect capturing device of claim 11, the nozzle being selectively extendable.

15. The insect capturing device of claim 11, the capture space being insect impermeable at an inward end for preventing an insect victim from being ingested into the interiorly defined space of the body.

16. The insect capturing device of claim 11 including the piston being translatably disposed in a space defined in the body, the space being at ambient conditions at all times until the occurrence of a biased translation of the piston.

17. The insect capturing device of claim 11 including the body being selectively vented to ambient air conditions on both of two opposed sides of the piston.

18. The insect capturing device of claim 11 including a vacuum being generated only while the piston is in translation from a cocked disposition to a stopped disposition, the body interior space being at ambient air pressure conditions at all other times.

19. A method capturing an insect, comprising
defining an interior space in a body;
disposing a nozzle proximate an insect victim, the nozzle being in fluid communication with the body interior space;
mechanically generating a momentary vacuum in the interior space of the body and in the nozzle to substantially instantaneously draw an insect victim into a sealable capture space, the capture space being in fluid communication with both the nozzle and the body interior space.

20. The method of claim 19, including generating the vacuum only while the piston is in translation from a cocked disposition to a stopped disposition, the body interior space being at ambient air pressure conditions at all other times.
